(19) United States
(12) Patent Application Publication
(10) Pub. No.: US 2025/0097894 A1
(43) Pub. Date: Mar. 20, 2025

(54) POSITIONING METHOD, ELECTRONIC DEVICE, COMPUTER-READABLE STORAGE MEDIUM AND POSITIONING SYSTEM

(71) Applicants: GREE ELECTRIC APPLIANCES, INC. OF ZHUHAI, Zhuhai (CN); LEAYUN TECHNOLOGY CO., LTD. OF ZHUHAI, Zhuhai (CN)

(72) Inventors: Lifu WANG, Zhuhai (CN); Yang DU, Zhuhai (CN); Yanyu CHEN, Zhuhai (CN); Xiangpeng YIN, Zhuhai (CN); Tengda WANG, Zhuhai (CN); Dingqiang CHEN, Zhuhai (CN)

(73) Assignees: GREE ELECTRIC APPLIANCES, INC. OF ZHUHAI, Zhuhai (CN); LEAYUN TECHNOLOGY CO., LTD. OF ZHUHAI, Zhuhai (CN)

(21) Appl. No.: 18/971,636

(22) Filed: Dec. 6, 2024

Related U.S. Application Data
(63) Continuation of application No. PCT/CN2022/139718, filed on Dec. 16, 2022.

(30) Foreign Application Priority Data
Jun. 20, 2022 (CN) 202210700298.1

(51) Int. Cl. H04W 64/00; H04B 17/318

(52) U.S. Cl. CPC H04W 64/00; H04B 17/318

(57) ABSTRACT

A positioning method includes: obtaining an integrated signal strength and a first-path signal strength; obtaining an initial distance value between a sending device and a receiving device, and initial position information of the sending device; determining a correction distance value according to the integrated signal strength and the first-path signal strength, and correcting the initial distance value by using the correction distance value, to obtain a target distance value; and correcting the initial position information according to the target distance value, to obtain target position information.

### CROSS-REFERENCE TO RELATED APPLICATIONS

The present disclosure is a continuation of International Application No. PCT/CN2022/139718, filed on Dec. 16, 2022, which claims priority to Chinese Patent Application No. 202210700298.1, filed on Jun. 20, 2022. The disclosures of the aforementioned applications are hereby incorporated by reference in their entireties.

### TECHNICAL FIELD

The present disclosure relates to the field of communications, and in particular, to a positioning method, an electronic device, a computer-readable storage medium and a positioning system.

### BACKGROUND

With the continuous development of wireless technology, wireless technology has been used for ranging/positioning between devices, but wireless electromagnetic waves are easily affected by environmental factors, such as temperature and humidity, electromagnetic interference, metal shielding, wall obstruction or human influence, which will have a great impact on wireless signals, such as wireless signals are greatly attenuated or produces reflection, diffraction, etc., so that a propagation speed of an electromagnetic wave signal in air is changed, thereby increasing a flight time of the electromagnetic wave signal in air, delaying radio signals, resulting in a large deviation between a measurement result and a true value, and further occurring non line of sight (NLOS) phenomenon. Ultra wide band (UWB) is a centimeter-level wireless positioning device, and in a serious NLOS environment, the measurement error will even exceed a meter level. In actual use process, many factors will cause NLOS phenomenon, but this influence cannot be directly avoided, and current UWB devices in the NLOS environment have poor positioning accuracy.

### SUMMARY

The main objective of the present disclosure is to provide a positioning method, an electronic device, a computer-readable storage medium and a positioning system, to solve the problem in the related technologies of poor positioning accuracy of UWB devices.

According to an aspect of embodiments of the present disclosure, a positioning method is provided, including: obtaining an integrated signal strength and a first-path signal strength, where the integrated signal strength is determined according to strengths of a plurality of signals sent by a sending device, and the first-path signal strength is a strength of the first signal received by a receiving device; obtaining an initial distance value between the sending device and the receiving device, and an initial position information of the sending device; determining a correction distance value according to the integrated signal strength and the first-path signal strength, and correcting the initial distance value by using the correction distance value, to obtain a target distance value; and correcting the initial position information according to the target distance value, to obtain a target position information.

Optionally, the obtaining an initial distance value between the sending device and the receiving device includes: obtaining a first difference value between the integrated signal strength and the first-path signal strength; and determining the initial distance value between the sending device and the receiving device according to the first difference value.

Optionally, the determining the initial distance value between the sending device and the receiving device according to the first difference value includes: when the first difference value is smaller than a first threshold value, obtaining a first timestamp, a second timestamp, a clock frequency offset and a propagation speed of electromagnetic wave, where the first timestamp refers to a timestamp for sending a data packet by the sending device, and the second timestamp refers to a timestamp for receiving the data packet by the receiving device; determining an actual time consumption according to the first timestamp, the second timestamp and the clock frequency offset, where the actual time consumption refers to a time actually consumed for the data packet to be sent from the sending device to the receiving device; and determining the initial distance value between the sending device and the receiving device according to the actual time consumption and the propagation speed of electromagnetic wave.

Optionally, the method further includes: when the first difference value is greater than or equal to the first threshold value, determining that a signal corresponding to the integrated signal strength and a signal corresponding to the first-path signal strength are both invalid signals.

Optionally, the integrated signal strength includes a first-type integrated signal strength and a second-type integrated signal strength, the first-path signal strength includes a first-type first-path signal strength and a second-type first-path signal strength, and the first-type integrated signal strength and the first-type first-path signal strength are obtained in a first scene, the second-type integrated signal strength and the second-type first-path signal strength are obtained in a second scene, where the first scene refers to a scene in which there is no obstruction between the sending device and the receiving device, and the second scene refers to a scene in which there is an obstruction between the sending device and the receiving device, the determining a correction distance value according to the integrated signal strength and the first-path signal strength includes: obtaining a second difference value between the first-type integrated signal strength and the second-type integrated signal strength; obtaining a third difference value between the first-type first-path signal strength and the second-type first-path signal strength; and determining the correction distance value according to the second difference value and the third difference value.

Optionally, the determining the correction distance value according to the second difference value and the third difference value includes: when the second difference value is smaller than a second threshold value, and the third difference value is smaller than or equal to a third threshold value, determining that the correction distance value is a first correction distance value; when the second difference value is smaller than the second threshold value, the third difference value is greater than the third threshold value, and the third difference value is smaller than a fourth threshold value, determining that the correction distance value is a second correction distance value, where the fourth threshold value is greater than the third threshold value, and the second correction distance value is greater than the first correction distance value; and when the second difference value is greater than or equal to the second threshold value and smaller than a fifth threshold value, and the third difference value is greater than the third threshold value and smaller than the fourth threshold value, determining that the correction distance value is a third correction distance value, where the fifth threshold value is greater than the second threshold value, and the third correction distance value is greater than the second correction distance value.

Optionally, the determining the correction distance value according to the second difference value and the third difference value further includes: when the second difference value is greater than or equal to the fifth threshold value, and the third difference value is greater than the third threshold value and smaller than the fourth threshold value, determining that the correction distance value is a fourth correction distance value, where the fourth correction distance value is greater than the third correction distance value; when the second difference value is greater than or equal to the second threshold value and smaller than the fifth threshold value, and the third difference value is greater than or equal to the fourth threshold value, determining that the correction distance value is a fifth correction distance value, where the fifth correction distance value is greater than the fourth correction distance value; and when the second difference value is greater than or equal to the fifth threshold value and the third difference value is greater than or equal to the fourth threshold value, determining that the correction distance value is a sixth correction distance value, where the sixth correction distance value is greater than the fifth correction distance value.

Optionally, the correcting the initial position information according to the target distance value, to obtain a target position information includes: determining a current state of the sending device, where the current state is obtained by using a gyroscope sensor, the gyroscope sensor is installed in the sending device, and the current state includes a static state and a motion state; and when the current state is the motion state, correcting the initial position information according to the target distance value, to obtain the target position information.

Optionally, the when the current state is the motion state, correcting the initial position information according to the target distance value, to obtain the target position information includes: obtaining a first initial position information at a first moment and a second initial position information at a second moment; determining whether an actual distance value is equal to the target distance value, where the actual distance value is a distance value of the second initial position information of the sending device relative to a position information of the receiving device; and when the actual distance value is not equal to the target distance value, correcting the second initial position information according to the first initial position information at the first moment and the second initial position information at the second moment, to obtain the target position information.

Optionally, when the motion state is a linear motion status and the actual distance value is not equal to the target distance value, the correcting the second initial position information according to the first initial position information at the first moment and the second initial position information at the second moment, to obtain the target position information includes: constructing a first function relationship by using a plurality of the first initial position information at the first moment and the second initial position information at the second moment; and correcting the second initial position information according to the first function relationship, to obtain the target position information.

Optionally, when the motion state is a non-linear motion status and the actual distance value is not equal to the target distance value, the correcting the second initial position information according to the first initial position information at the first moment and the second initial position information at the second moment, to obtain the target position information includes: determining whether an actual direction is the same as a target direction, where the actual direction refers to a direction of the second initial position information of the sending device relative to the position information of the receiving device; when the actual direction is different from the target direction, obtaining a correction slope parameter and a turning angle parameter; constructing a second function relationship by using the first initial position information at a plurality of the first moment, the second initial position information at the second moment, the correction slope parameter and the turning angle parameter; and correcting the second initial position information according to the second function relationship, to obtain the target position information.

Optionally, the positioning method further includes: when the current state is the static state, determining not to correct the initial position information; and continuously obtaining the initial position information at a plurality of moments, obtaining an average value of a plurality of initial position information, and determining the average value as the target position information.

Optionally, the correcting the initial distance value by using the correction distance value, to obtain a target distance value includes: obtaining a fourth difference value between the initial distance value and the correction distance value; and determining the fourth difference value as the target distance value.

Optionally, the sending device includes a first UWB device, and the receiving device includes a second UWB device.

According to another aspect of the embodiments of the present disclosure, a positioning apparatus is further provided, including: a first obtaining unit, configured to obtain an integrated signal strength and a first-path signal strength, wherein the integrated signal strength is determined according to strengths of a plurality of signals sent by a sending device, and the first-path signal strength is a strength of the first signal received by a receiving device; a second obtaining unit, configured to obtain an initial distance value between the sending device and the receiving device, and an initial position information of the sending device; a first determination unit, configured to determine a correction distance value according to the integrated signal strength and the first-path signal strength, and correct the initial distance value by using the correction distance value, to obtain a target distance value; and a correction unit, configured to correct the initial position information according to the target distance value, to obtain a target position information.

According to still another aspect of the embodiments of the present disclosure, a computer-readable storage medium is further provided, including a stored program, which executes any one of the methods.

According to yet another aspect of the embodiments of the present disclosure, a positioning system is also provided, including a sending device, a receiving device and a positioning device, where the positioning device communicates with the sending device and the receiving device respectively, and the positioning device is configured to execute any one of the methods.

In the positioning method of the present disclosure, obtaining the integrated signal strength and the first-path signal strength at first, then obtaining the initial distance value between the sending device and the receiving device, and the initial position information of the sending device, next determining the correction distance value according to the integrated signal strength and the first-path signal strength, and correcting the initial distance value by using the correction distance value, to obtain the target distance value, and finally correcting the initial position information according to the target distance value, to obtain the target position information. In this solution, the position information of the sending device is corrected through multiple steps in NLOS environment, which may correct the position information and navigation route of the sending device in the NLOS environment, and therefore reducing the influence degree of the positioning of the sending device in the NLOS environment, further improving positioning accuracy of the sending device in the NLOS environment. Meanwhile, the solution can reduce the deviation of the radio communication ranging or positioning position, so that the measurement value in the NLOS environment is closer to the actual value.

### BRIEF DESCRIPTION OF THE DRAWINGS

The accompanying drawings, which constitute a part of the present disclosure, are used to provide a further understanding of the present disclosure, and the illustrative embodiments of the present disclosure and the description thereof are used to explain the present disclosure and do not constitute an improper limitation on the present disclosure.

FIG. 1 is a flowchart of a positioning method according to an embodiment of the present disclosure.

FIG. 2 is a schematic structural diagram of a sending device.

FIG. 3 is a schematic diagram of a partial structure of a sending device.

FIG. 4 is a schematic diagram of measuring an initial distance value between a sending device and a receiving device.

FIG. 5 is a schematic diagram of correction in a linear motion status.

FIG. 6 is a schematic diagram of correction in a non-linear motion status.

FIG. 7 is a schematic structural diagram of a positioning apparatus according to an embodiment of the present disclosure.

FIG. 8 is a flowchart of another positioning method according to an embodiment of the present disclosure.

### DETAILED DESCRIPTION OF THE EMBODIMENTS

It should be noted that, in the case of no conflict, embodiments in the present disclosure and features in the embodiments may be combined with each other. The following describes the present disclosure in detail with reference to the accompanying drawings and in combination with the embodiments.

In order to enable a person of ordinary skill in the art to better understand the solutions of the present disclosure, the following clearly describes the technical solutions in the embodiments of the present disclosure with reference to the accompanying drawings in the embodiments of the present disclosure. Apparently, the described embodiments are a part rather than all of the embodiments of the present disclosure. All other embodiments obtained by a person of ordinary skill in the art based on the embodiments of the present disclosure without creative efforts shall fall within the protection scope of the present disclosure.

It should be noted that, the terms “first”, “second” and the like in the specification, claims, and accompanying drawings of the present disclosure are used to distinguish similar objects, and are not necessarily used to describe a specific order or sequence. It should be understood that the data used in this way may be interchanged under appropriate circumstances, to facilitate the embodiments of the present disclosure described herein. In addition, the terms “including”, “comprising” and any variations thereof are intended to cover a non-exclusive inclusion, for example, a process, method, system, product or device that includes a series of steps or units is not necessarily limited to those steps or units listed clearly, but may include other steps or units that are not clearly listed or inherent to such process, method, product or device.

It should be understood that, when an element (such as a layer, film, region, or substrate) is described as being “on” another element, the element may be directly on the other element or intervening elements may be present between them. Moreover, in the specification and the claims, when an element is described as being “connected” to another element, the element may be “directly connected” to the other element, or “connected” to the other element by using a third element.

As described in the background, in the related technologies, UWB devices have poor positioning accuracy, and in order to solve the above problem, embodiments of the present disclosure provide a positioning method, a positioning apparatus, a computer-readable storage medium and a positioning system.

According to an embodiment of the present disclosure, a positioning method is provided.

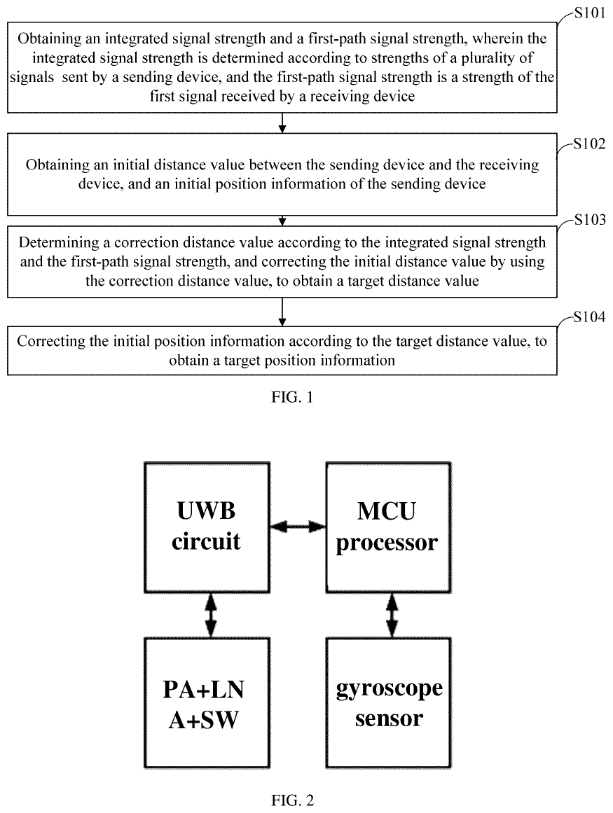

FIG. 1 is a flowchart of a positioning method according to an embodiment of the present disclosure. As shown in FIG. 1, The method including the following contents.

S101, obtaining an integrated signal strength and a first-path signal strength, wherein the integrated signal strength is determined according to strengths of a plurality of signals sent by a sending device, and the first-path signal strength is a strength of the first signal received by a receiving device.

S102, obtaining an initial distance value between the sending device and the receiving device, and an initial position information of the sending device.

S103, determining a correction distance value according to the integrated signal strength and the first-path signal strength, and correcting the initial distance value by using the correction distance value, to obtain a target distance value.

S104, correcting the initial position information according to the target distance value, to obtain a target position information.

Specifically, the sending device includes a UWB device. The solution is applicable to positioning of a UWB device in an NLOS environment. In this way, correction is performed through multiple steps in NLOS environment, which may correct position information and navigation route of the UWB device in the NLOS environment, and therefore reducing an influence degree of the positioning of the UWB device in the NLOS environment, further improving positioning accuracy of the UWB device in the NLOS environment. Meanwhile, the solution can reduce a deviation of radio communication ranging or positioning position, so that a measurement value in the NLOS environment is closer to an actual value.

In the above method, firstly, obtaining the integrated signal strength and the first-path signal strength, then obtaining the initial distance value between the sending device and the receiving device, and the initial position information of the sending device, next determining the correction distance value according to the integrated signal strength and the first-path signal strength, and correcting the initial distance value by using the correction distance value, to obtain the target distance value, and finally correcting the initial position information according to the target distance value, to obtain the target position information. In this solution, the position information of the sending device is corrected through multiple steps in NLOS environment, which may correct the position information and navigation route of the sending device in the NLOS environment, and therefore reducing the influence degree of the positioning of the sending device in the NLOS environment, further improving positioning accuracy of the sending device in the NLOS environment. Meanwhile, the solution can reduce the deviation of the radio communication ranging or positioning position, so that the measurement value in the NLOS environment is closer to the actual value.

It should be noted that steps shown in the flowcharts of the accompanying drawings may be executed in a computer system such as a set of computer executable instructions, and although a logical order is shown in the flowcharts, in some cases, the steps shown or described may be executed in an order different from that described herein.

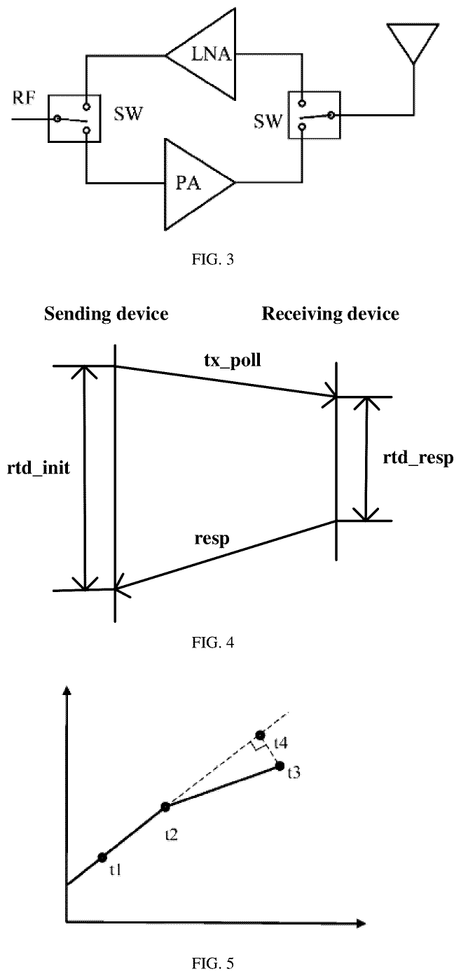

Specifically, in an actual application, the sending device of the present solution is shown in FIG. 2, an implementation of the solution may be established on a hardware, and the sending device mainly includes a UWB circuit, an MCU (micro control unit) processor, a PA (amplification circuit)+LNA (noise amplifier)+SW (switch) high-power circuit and a six-axis acceleration sensor circuit (may be a gyroscope sensor), where the PA+LNA+SW high-power circuit may play a role in inhibiting a transmitting signal and a receiving signal in the NLOS environment, so that signals are less interfered, part of noise signals can be removed, and a greater signal margin and quality can be provided for the receiving device. Meanwhile, the PA+LNA+SW high-power circuit may reduce an NLOS environment reflection effect on signal caused by shielding, environmental noise, etc., and has a suppression effect in the radio NLOS environment, which is mainly because the PA+LNA+SW high-power circuit can distinguish signals into an integrated signal strength and a first-path signal strength. The PA+LNA+SW high-power circuit is shown in FIG. 3, including PA, LNA, two SW and ANT (antennas), where RF shown in FIG. 3 is electrically connected with the UWB circuit.

In addition, the UWB circuit further includes a UWB chip from decawave company, the chip has a function of reading the integrated signal strength and the first-path signal strength in the signal transmission process and may be set a threshold value of an effective received signal strength to 13, so that an influence of the NLOS environment and an influence of environmental noise under the UWB device can be balanced. When the sending device is in a motion status, correction may be performed in the ranging process according to the integrated signal strength and the first-path signal strength during an information interaction process, where the integrated signal strength mainly reflects the quality of all signals in the entire receiving process. Specifically, it may be an average value of all received signals or a predetermined signal strength which may be greater than 80% of the signal strength of all signals, and the first-path signal strength mainly reflects the received signal strength of the first signal arrived at a receiving end, whether the transmitted signal has been reflected and been affected by the NLOS environment may be determined according to the integrated signal strength and the first-path signal strength, and a greater difference value between the two signal strengths indicates the worse NLOS environment.

In some embodiments of the present disclosure, the obtaining an initial distance value between the sending device and the receiving device includes: obtaining a first difference value between the integrated signal strength and the first-path signal strength; and determining the initial distance value between the sending device and the receiving device according to the first difference value. In this embodiment, the first difference value may indicate whether reflection occurs in a process of transmitting a signal between the sending device and the receiving device and the signal has been affected by the NLOS environment, so that the initial distance value between the sending device and the receiving device may be more accurately determined according to the first difference value.

In some other embodiments of the present disclosure, the determining the initial distance value between the sending device and the receiving device according to the first difference value includes: when the first difference value is smaller than a first threshold value, obtaining a first timestamp, a second timestamp, a clock frequency offset and a propagation speed of electromagnetic wave, where the first timestamp refers to a timestamp for sending a data packet by the sending device, and the second timestamp refers to a timestamp for receiving the data packet by the receiving device; determining an actual time consumption according to the first time stamp, the second time stamp and the clock frequency offset, where the actual time consumption refers to a time actually consumed for the data packet to be sent form the sending device to the receiving device; and determining the initial distance value between the sending device and the receiving device according to the actual time consumption and the propagation speed of electromagnetic wave. In this embodiment, the actual time consumption may be accurately determined by using the first timestamp, the second timestamp and the clock frequency offset, so that the initial distance value between the sending device and the receiving device may be further accurately determined according to the actual time consumption and the propagation speed of electromagnetic wave.

Specifically, as shown in FIG. 4, the sending device sends a probe frame signal (tx_poll Message), the receiving device in an effective range receives the signal and records the integrated signal strength and the first-path signal strength, and records the first timestamp. Only when the integrated signal strength is greater than a threshold value RISS_k, and the first difference value between the first-path signal strength and the integrated signal strength is smaller than 6 db, a distance between the sending device and the receiving device will be considered to be relatively close, and the environment is a Line of Sight (LOS) environment or an environment with less NLOS impact, and the sending device may be used as a ranging sending device, otherwise, it is considered that the environment is an NLOS environment. Because a signal flight time in the NLOS environment is longer, a signal capability attenuation is greater, an environmental interference is greater and a generated error also is greater, so it is not suitable for being used as a ranging input value. After receiving the message, the receiving device meeting the requirement will return a reply frame message (resp message) to the sending device; and the sending device records the second timestamp and the clock frequency offset, then calculates the actual consumption by using the following formula:

$$t = \frac{( rtd\_init - rtd\_resp \times ( 1 - {f}_{clockOffset} ) )}{2}$$

where t represents the actual time consumption, rtd_init represents the first timestamp, rtd_resp represents the second timestamp, f_{clockOffset} represents the clock frequency offset, and then the initial distance value is calculated by using the following formula: d=t×c, where d represents the initial distance value, c represents the propagation speed of electromagnetic wave. Only the measured initial distance value is less affected by the NLOS environment or is in the LOS environment, it may be used as a data input of TOF position algorithm.

In some other embodiments of the present disclosure, the above method further includes: when the first difference value is greater than or equal to the first threshold value, determining that a signal corresponding to the integrated signal strength and a signal corresponding to the first-path signal strength are both invalid signals. In this embodiment, when the first difference value between the integrated signal strength and the first-path signal strength is greater than or equal to the first threshold value, the two signals are considered to be invalid signals, so that data severely affected by the NLOS environment can be screened out, to obtain data in the LOS environment or data less affected by the NLOS environment, and therefore reducing the influence of the NLOS environment on positioning. Generally, distance measurement may be performed between the sending device and the nearest receiving device, to reduce an environmental influence degree on signal quality, if a severe NLOS environment occurs at a relatively close distance, the receiving device at a longer distance needs to be replaced, to reduce the influence of the NLOS environment. This embodiment can filter the data in the NLOS environment.

In some other embodiments of the present disclosure, the integrated signal strength includes a first-type integrated signal strength and a second-type integrated signal strength, the first-path signal strength includes a first-type first-path signal strength and a second-type first-path signal strength, and the first-type integrated signal strength and the first-type first-path signal strength are obtained in a first scene, the second-type integrated signal strength and the second-type first-path signal strength are obtained in a second scene, where the first scene refers to a scene in which there is no obstruction between the sending device and the receiving device, and the second scene refers to a scene in which there is an obstruction between the sending device and the receiving device. The determining a correction distance value according to the integrated signal strength and the first-path signal strength includes: obtaining a second difference value between the first-type integrated signal strength and the second-type integrated signal strength; obtaining a third difference value between the first-type first-path signal strength and the second-type first-path signal strength; and determining the correction distance value according to the second difference value and the third difference value. In this embodiment, although the data severely affected by the NLOS environment has been filtered out before, a data less affected by the NLOS environment may also exist. As the distance between the sending device and the receiving device varies, the interference that occurs or the degree affected by the NLOS environment is also different, and therefore parameters of the first scene (i.e., the LOS environment) and parameters of the second scene (i.e., the NLOS environment) may be used to determine whether reflection has occurred, and further a function curve may be constructed by using the first-type integrated signal strength and the first-type first-path signal strength, which may be used as a reference data for comparison with the second-type integrated signal strength and the second-type first-path signal strength, to determine the correction distance value more accurately.

To further accurately determine the correction distance value, in some other embodiments of the present disclosure, the determining the correction distance value according to the second difference value and the third difference value includes: when the second difference value is smaller than a second threshold value, and the third difference value is smaller than or equal to a third threshold value, determining that the correction distance value is a first correction distance value; when the second difference value is smaller than the second threshold value, the third difference value is greater than the third threshold value, and the third difference value is smaller than a fourth threshold value, determining that the correction distance value is a second correction distance value, where the fourth threshold value is greater than the third threshold value, and the second correction distance value is greater than the first correction distance value; and when the second difference value is greater than or equal to the second threshold value and smaller than a fifth threshold value, and the third difference value is greater than the third threshold value and smaller than the fourth threshold value, determining that the correction distance value is a third correction distance value, where the fifth threshold value is greater than the second threshold value, and the third correction distance value is greater than the second correction distance value.

To further accurately determine the correction distance value, in some other embodiments of the present disclosure, the determining the correction distance value according to the second difference value and the third difference value further includes: when the second difference value is greater than or equal to the fifth threshold value, and the third difference value is greater than the third threshold value and smaller than the fourth threshold value, determining that the correction distance value is a fourth correction distance value, where the fourth correction distance value is greater than the third correction distance value; when the second difference value is greater than or equal to the second threshold value and smaller than the fifth threshold value, and the third difference value is greater than or equal to the fourth threshold value, determining that the correction distance value is a fifth correction distance value, where the fifth correction distance value is greater than the fourth correction distance value; and when the second difference value is greater than or equal to the fifth threshold value and the third difference value is greater than or equal to the fourth threshold value, determining that the correction distance value is a sixth correction distance value, where the sixth correction distance value is greater than the fifth correction distance value.

Specifically, in a first scene, the first-type integrated signal strength is denoted as RX_level(x), the first-type first-path signal strength is denoted as First_level(x), and x is the measurement distance (x=0˜100 m). Generally, an initial distance value in the NLOS environment may be greater than an initial distance value in the actual situation (ranging from 10 cm to 2 m), but generally not smaller. If a signal strength in a second scene is smaller than a signal strength in the first scene, it means that there is occlusion. The second-type integrated signal strength in the second scene is denoted as A(x), the second-type first-path signal strength is B(x), whether a reflection is generated, an error analysis of the initial distance value L, and a correction distance value has the following cases.

In a first case: A(x)−RX_level(x)<0.5 db, and B(x)−First_level(x)≤0.5 db, it represents in a LOS environment, a received signal is slightly occluded or non-occluded, the received signal is a direct signal, a distance error err=0, and a correction distance value L_{K} is 0.

In a second case: A(x)−RX_level(x)<0.5 db, and 5<[B(x)−First_level(x)]<10 db, it represents in a general NLOS environment, a received signal is generally occluded, a determination signal is a direct signal, and a measurement error is mainly caused by a relatively slow propagation speed of the electromagnetic wave when encountering a transmission medium. Through multiple measurements, it can be found that in the second case, the strength of the received signal and the distance error have greater influence factors, A(x)−RX_level(x) can be used as a correction factor, the distance error is increased by about 10 cm to 30 cm, and a correction distance value L_{K}=50A(x)−RX_level(x), L_{K}<30 cm.

In a third case: 0.5≤(A(x)−RX_level(x))<6 db, and 5<[B(x)−First_level(x)]<10 db, it represents in a relatively serious NLOS environment, a received signal is seriously occluded, a distance error is increased by about 20 cm to 60 cm, but the signal is still a direct signal, and a correction distance value L_{K}=20A(x)−RX_level(x), L_{K}<60 cm.

In a fourth case: ((A(x)−RX_level(x))≥6 db, and 5<[B(x)−First_level(x)]<10 db, it represents in a very serious NLOS environment, a received signal is extremely seriously occluded, a distance error is increased by about 80 cm or more, but the signal is still may be a direct signal, and a correction distance value L_{K}=15[A(x)−RX_level(x)], L_{K}<100 cm.

In a fifth case: 0.5≤(A(x)−RX_level(x))<6 db, and [B(x)−First_level(x)]≥10 db, it represents in a relatively serious NOS environment, a received signal is seriously occluded, a distance error is increased by about 50 cm to 100 cm. It has a great probability that the received signal is a reflection signal, a correction distance value L_{K}=5[A(x)−RX_level(x)]+[B(x)−First_level(x)], L_{K}<150 cm.

In a sixth case: (A(x)−RX_level(x))≥6 db, and [B(x)−First_level(x)]≥10 db, it represents in a severe NLOS environment, a received signal is seriously occluded, a distance error is increased by about 100 cm or more, the received signal is a reflected signal, and a correction distance value L_{K}=10[A(x)−B(x)], L_{K}<200 cm.

In some specific embodiments of the present disclosure, the correcting the initial position information according to the target distance value, to obtain the target position information includes: determining a current state of the sending device, where the current state is obtained by using a gyroscope sensor which is installed in the sending device, and the current state includes a static state and a motion state; and when the current state is the motion state, correcting the initial position information according to the target distance value, to obtain the target position information. In this embodiment, the initial position information may be further corrected, the gyroscope sensor has a good feedback effect on position and direction, and therefore the gyroscope sensor may be used to correct the initial position information, to make the output target position information is closer to the actual situation, so that an error fluctuation is reduced.

In some other embodiments of the present disclosure, the when the current state is the motion state, correcting the initial position information according to the target distance value, to obtain the target position information includes: obtaining a first initial position information at a first moment and a second initial position information at a second moment; determining whether an actual distance value is equal to the target distance value, where the actual distance value is a distance value of the second initial position information of the sending device relative to position information of the receiving device; and when the actual distance value is not equal to the target distance value, correcting the second initial position information according to the first initial position information at the first moment and the second initial position information at the second moment, to obtain the target position information. In this embodiment, the initial position information may be further corrected, to ensure the obtained target position information is more accurate, further improving the positioning accuracy of the sending device in the NLOS environment.

In some still other embodiments of the present disclosure, when the motion state is a linear motion status and the actual distance value is not equal to the target distance value, the correcting the second initial position information according to the first initial position information at the first moment and the second initial position information at the second moment, to obtain the target position information includes: constructing a first function relationship by using a plurality of the first initial position information at the first moment and the second initial position information at the second moment; and correcting the second initial position information according to the first function relationship, to obtain the target position information. In this embodiment, when the motion state is a linear motion status, the initial position information may be further corrected, to ensure the obtained target position information is more accurate, further improving the positioning accuracy of the sending device in the NLOS environment.

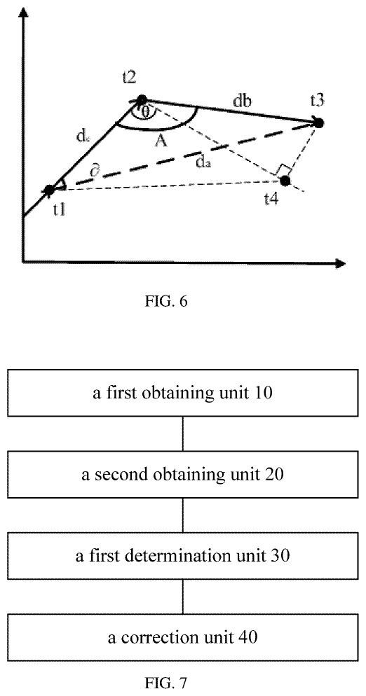

In some embodiments, a schematic diagram of correction in a linear motion status is as shown in FIG. 5, the positioning is performed three times at the first moment. If the gyroscope sensor detects that an angle change exceeds 5°, it is considered that the correction is required, and if not, it is considered that the correction is not required. If a first initial position information is detected at t1 moment and t2 moment, the angle change both less than 5°, then a second initial position information is detected at t3 moment, but an offset angle of the t3 moment relative to t1 moment and t2 moment is calculated to be greater than 5° according to the TOF algorithm, which means that the influence of the NLOS environment still exists, so it is necessary to perform correction, where the first initial position information at t1 moment is (x₁, y₁), the first initial position information at t2 moment is (x₂, y₂), the second initial position information at t3 moment is (x₃,y₃), and the target position information after being corrected is set to be t4(x₄,y₄), The function composed of t1 and t2 is:

$$y = qx + p , \qquad Formula 1$$

$$where$$

$$q = \frac{{y}_{2} - {y}_{1}}{{x}_{2} - {x}_{1}} ,$$

$$q = \frac{{y}_{1} {x}_{2} - {y}_{2} {x}_{1}}{{x}_{2} - {x}_{1}} ,$$

A triangle enclosed by t2, t3 and t4 is obtained according to a triangular formula:

$$Formula 2$$

$${( {x}_{2} - {x}_{3} )}^{2} + {( {y}_{2} - {y}_{3} )}^{2} = {( {x}_{3} - {x}_{4} )}^{2} + {( {y}_{3} - {y}_{4} )}^{2} + {( {x}_{2} - {x}_{4} )}^{2} + {( {y}_{2} - {y}_{4} )}^{2} ,$$

simplified results:

$$( {x}_{4} - {x}_{2} ) ( {x}_{3} - {x}_{4} ) + ( {y}_{4} - {y}_{2} ) ( {y}_{3} - {y}_{4} ) = 0 \qquad Formula 3$$

According to Formula 1 and Formula 2:

$${x}_{4} = \frac{- b \pm \sqrt{{b}^{2} - 4 ac}}{2 a} ,$$

$${y}_{4} = {qx}_{4} + p ;$$

$$where$$

$$a = - ( 1 + {q}^{2} ) ,$$

$$b = ( {x}_{2} + {x}_{3} + q ( {y}_{2} + {y}_{3} ) + 2 qp ) ,$$

$$c = {p}^{2} + p ( {y}_{2} + {y}_{3} ) - {x}_{2} {x}_{3} - {y}_{2} {y}_{3} ;$$

When it is detected that an attitude angle is offset to left,

$${x}_{4} = \frac{- b - \sqrt{{b}^{2} - 4 ac}}{2 a} ,$$

$${y}_{4} = {qx}_{4} + p ,$$

When it is detected that the attitude angle is offset to right,

$${x}_{4} = \frac{- b + \sqrt{{b}^{2} - 4 ac}}{2 a} ,$$

$${y}_{4} = {qx}_{4} + p ,$$

Therefore, the obtained target position information is (x₃,y₄), and the initial position information of each positioning is correspondingly corrected, so that the measured navigation route is closer to the actual situation.

In some other specific embodiments of the present disclosure, when the motion state is a non-linear motion status and the actual distance value is not equal to the target distance value, the correcting the second initial position information according to the first initial position information at the first moment and the second initial position information at the second moment, to obtain the target position information includes: determining whether an actual direction is the same as a target direction, where the actual direction refers to a direction of the second initial position information of the sending device relative to the position information of the receiving device; when the actual direction is different from the target direction, obtaining a correction slope parameter and a turning angle parameter; constructing a second function relationship by using the first initial position information at a plurality of the first moment, the second initial position information at the second moment, the correction slope parameter and the turning angle parameter; and correcting the second initial position information according to the second function relationship, to obtain the target position information. In this embodiment, when the motion state is a non-linear motion state, the initial position information may be further corrected, to ensure the obtained target position information is more accurate, further improving the positioning accuracy of the sending device in the NLOS environment.

In some embodiments, a schematic diagram of correction in a non-linear motion state is shown in FIG. 6, compared with linear motion, the correction of the non-linear motion state (turning state) is different. A target direction detected by the previous gyroscope sensor at the time before last time and the last time are used as reference, the gyroscope sensor can detect an offset angle of an actual direction, assuming that a predicted target position information is the offset angle θ detected by the gyroscope sensor, and when an angle, detected by the gyroscope sensor, formed by an offset of the horizontal posture relative to a target position information calculated by the TOF algorithm is greater than or equal to 5°, the motion is considered to be non-linear, and the offset angle needs to be corrected. t1 is the first initial position information after correction of the time before last time, t2 is the first initial position information after the correction of last time, t3 is the second initial position information calculated by the TOF algorithm and t4 is the target position information. Assuming that a horizontal coordinates of t1 is (x₁, y₁), t2 is (x₂,y₂), and t3 is (x₃,y₃), and setting an corrected coordinate is t4(x₄,y₄), an angle change of the gyroscope sensor relative to the last detected horizontal direction is θ, and a slope of the linear equation composed of t1 and t2 is:

$${k}_{1} = \frac{{y}_{2} - {y}_{1}}{{x}_{2} - {x}_{1}} = tan \partial , \qquad Formula 4$$

$$\partial = arctan ( {k}_{1} ) = arctan ( \frac{{y}_{2} - {y}_{1}}{{x}_{2} - {x}_{1}} ) ,$$

A linear equation composed of t2 and t4 is y=mx+n, the slope of the equation is:

$$m = \frac{{y}_{2} - {y}_{4}}{{x}_{2} - {x}_{4}} = tan ( π - \partial - θ ) , \qquad Formula 5$$

In addition, since the linear equation passes through t2, then y₂=mx₂+n, that is, n=y₂−mx₂, therefore the equation is:

$$y = mx + ( {y}_{2} - {mx}_{2} ) , \qquad Formula 6$$

The triangle enclosed by t2, t3 and t4 is obtained according to the triangular formula:

$$Formula 7$$

$${( {x}_{2} - {x}_{3} )}^{2} + {( {y}_{2} - {y}_{3} )}^{2} = {( {x}_{3} - {x}_{4} )}^{2} + {( {y}_{3} - {y}_{4} )}^{2} + {( {x}_{2} - {x}_{4} )}^{2} + {( {y}_{2} - {y}_{4} )}^{2} ,$$

simplified results:

$$( {x}_{4} - {x}_{2} ) ( {x}_{3} - {x}_{4} ) + ( {y}_{4} - {y}_{2} ) ( {y}_{3} - {y}_{4} ) = 0 \qquad Formula 8$$

According to Formula 6 and Formula 8:

$${x}_{4} = \frac{- b \pm \sqrt{{b}^{2} - 4 ac}}{2 a} ,$$

$${y}_{4} = {mx}_{4} + ( {y}_{2} - {mx}_{2} ) ;$$

$$where$$

$$a = - ( 1 + {m}^{2} ) ,$$

$$b = ( {x}_{2} + {x}_{3} + m ( {y}_{2} + {y}_{3} ) + 2 m ( {y}_{2} - {mx}_{2} ) ) ,$$

$$c = {m}^{2} + ( {y}_{2} - {mx}_{2} ) ( {y}_{2} + {y}_{3} ) - {x}_{2} {x}_{3} - {y}_{2} {y}_{3}$$

Angle A is an angle of the measured rotation angle preliminarily calculated through the TOF algorithm. Assuming that a distance between t1 and t2 is d_{c}, an distance between t1 and t3 is dₐ, an distance between t2 and t3 is d_{b}, and it is obtained in Δt1t2t3:

$$cos A = ( \frac{{d}_{b}^{2} + {d}_{c}^{2} - {d}_{a}^{2}}{2 {d}_{b} {d}_{c}} ) , \qquad Formula 9$$

$$where$$

$${d}_{a} = \sqrt{{( {x}_{1} - {x}_{3} )}^{2} + {( {y}_{1} - {y}_{3} )}^{2}} ,$$

$${d}_{b} = \sqrt{{( {x}_{2} - {x}_{3} )}^{2} + {( {y}_{2} - {y}_{3} )}^{2}} ,$$

$${d}_{c} = \sqrt{{( {x}_{1} - {x}_{2} )}^{2} + {( {y}_{1} - {y}_{2} )}^{2}}$$

Then, the calculated angle A of the measured rotation angle is:

$$A = arc cos ( \frac{{d}_{b}^{2} + {d}_{c}^{2} - {d}_{a}^{2}}{2 {d}_{b} {d}_{c}} ) ,$$

When A>θ, a corrected target position information is:

$${x}_{4} = \frac{- b + \sqrt{{b}^{2} - 4 ac}}{2 a} ,$$

$${y}_{4} = {mx}_{4} + ( {y}_{2} - {mx}_{2} ) ,$$

When A<θ, a corrected target position information is:

$${x}_{4} = \frac{- b - \sqrt{{b}^{2} - 4 ac}}{2 a} ,$$

$${y}_{4} = {mx}_{4} + ( {y}_{2} - {mx}_{2} ) .$$

To further accurately determine the target position information, in some other embodiments of the present disclosure, the method further includes: when the current state is the static state, determining not to correct the initial position information; continuously obtaining the initial position information at a plurality of moments, calculating an average value of a plurality of initial position information, and determining the average value as the target position information.

Specifically, in the static state, since an error of each measurement still exists, the position information of calculation and measurement still has a slight fluctuation, which is difficult to be visible by visual perception. The gyroscope sensor may be used for continuous positioning in the static state, the obtained distance values are 5.001 cm, 4.999 cm and 5.002 cm respectively, and an average value of the three data is taken as the target position information, so that a display effect is closer to the real value without slight fluctuation.

In some still other embodiments of the present disclosure, the correcting the initial distance value by using the correction distance value, to obtain a target distance value includes: obtaining a fourth difference value between the initial distance value and the correction distance value; and determining the fourth difference value as the target distance value. In this embodiment, when the correction distance value has been determined, the fourth difference value between the initial distance value and the correction distance value is determined as the target distance value, further accurately determining the target distance value between the sending device and the receiving device.

In some embodiments of the present disclosure, the sending device includes a first UWB device, and the receiving device includes a second UWB device. In this way, a positioning position of the UWB device in the NLOS environment may be calculated.

An embodiment of the present disclosure further provides a positioning apparatus. It should be noted that the positioning apparatus in the embodiments of the present disclosure may be configured to perform the positioning method provided in the embodiments of the present disclosure. The following describes the positioning apparatus provided in the embodiments of the present disclosure.

FIG. 7 is a schematic structural diagram of a positioning apparatus according to an embodiment of the present disclosure. As shown in FIG. 7, the apparatus includes a first obtaining unit 10, a second obtaining unit 20, a first determination unit 30 and a correction unit 40.

The first obtaining unit 10 is configured to obtain an integrated signal strength and a first-path signal strength, where the integrated signal strength is determined according to strengths of a plurality of signals sent by a sending device, and the first-path signal strength is a strength of the first signal received by a receiving device.

The second obtaining unit 20 is configured to obtain an initial distance value between the sending device and the receiving device, and an initial position information of the sending device.

The first determination unit 30 is configured to determine a correction distance value according to the integrated signal strength and the first-path signal strength, and correct the initial distance value by using the correction distance value, to obtain a target distance value.

The correction unit 40 is configured to correct the initial position information according to the target distance value, to obtain a target position information.

Specifically, the sending device includes a UWB device. The solution is applicable to positioning of a UWB device in an NLOS environment. In this way, correction is performed through multiple steps in NLOS environment, which may correct position information and navigation route of the UWB device in the NLOS environment, and therefore reducing an influence degree of the positioning of the UWB device in the NLOS environment, further improving positioning accuracy of the UWB device in the NLOS environment. Meanwhile, the solution can reduce a deviation of radio communication ranging or positioning position, so that a measurement value in the NLOS environment is closer to an actual value.

In the above apparatus, the first obtaining unit obtains the integrated signal strength and the first-path signal strength firstly, then the second obtaining unit obtains the initial distance value between the sending device and the receiving device, and the initial position information of the sending device, next the first determination unit determines the correction distance value according to the integrated signal strength and the first-path signal strength, and correcting the initial distance value by using the correction distance value to obtain the target distance value, and the correction unit corrects the initial position information according to the target distance value to obtain the target position information at last. In this solution, the position information of the sending device is corrected through multiple steps in NLOS environment, which may correct the position information and navigation route of the sending device in the NLOS environment, and therefore reducing the influence degree of the positioning of the sending device in the NLOS environment, further improving positioning accuracy of the sending device in the NLOS environment. Meanwhile, the solution can reduce the deviation of the radio communication ranging or positioning position, so that the measurement value in the NLOS environment is closer to the actual value.

In some embodiments of the present disclosure, the second obtaining unit includes a first obtaining module and a first determination module, where the first obtaining module is configured to obtain a first difference value between the integrated signal strength and the first-path signal strength; and the first determination module is configured to determine the initial distance value between the sending device and the receiving device according to the first difference value. In this embodiment, the first difference value may indicate whether reflection occurs in a process of transmitting a signal between the sending device and the receiving device and the signal has been affected by the NLOS environment, so that the initial distance value between the sending device and the receiving device may be more accurately determined according to the first difference value.

In some still other embodiments of the present disclosure, the first determination module includes a first obtaining sub-module, a first determination sub-module and a second determination sub-module, and the first obtaining sub-module is configured to: when the first difference value is smaller than a first threshold value, obtain a first timestamp, a second timestamp, a clock frequency offset and a propagation speed of electromagnetic wave, where the first timestamp refers to a timestamp for sending a data packet by the sending device, and the second timestamp refers to a timestamp for receiving the data packet by the receiving device; the first determination sub-module is configured to: determine an actual time consumption according to the first time stamp, the second time stamp and the clock frequency offset, where the actual time consumption refers to a time actually consumed for the data packet to be sent form the sending device to the receiving device; and the second determination sub-module is configured to: determine the initial distance value between the sending device and the receiving device according to the actual time consumption and the propagation speed of electromagnetic wave. In this embodiment, the actual time consumption may be accurately determined by using the first timestamp, the second timestamp and the clock frequency offset, so that the initial distance value between the sending device and the receiving device may be further accurately determined according to the actual time consumption and the propagation speed of electromagnetic wave.

In some yet other embodiments of the present disclosure, the apparatus further includes a second determination unit, configured to: when the first difference value is greater than or equal to the first threshold value, determine that a signal corresponding to the integrated signal strength and a signal corresponding to the first-path signal strength are both invalid signals. In this embodiment, when the first difference value between the integrated signal strength and the first-path signal strength is greater than or equal to the first threshold value, the two signals are considered to be invalid signals, so that data severely affected by the NLOS environment can be screened out, to obtain data in the LOS environment or data less affected by the NLOS environment, and therefore reducing the influence of the NLOS environment on positioning. Generally, distance measurement may be performed between the sending device and the nearest receiving device, to reduce an environmental influence degree on signal quality, if a severe NLOS environment occurs at a relatively close distance, the receiving device at a longer distance needs to be replaced, to reduce the influence of the NLOS environment. This embodiment can filter the data in the NLOS environment.

In some other embodiments of the present disclosure, the integrated signal strength includes a first-type integrated signal strength and a second-type integrated signal strength, the first-path signal strength includes a first-type first-path signal strength and a second-type first-path signal strength, and the first-type integrated signal strength and the first-type first-path signal strength are obtained in a first scene, the second-type integrated signal strength and the second-type first-path signal strength are obtained in a second scene, where the first scene refers to a scene in which there is no obstruction between the sending device and the receiving device, and the second scene refers to a scene in which there is an obstruction between the sending device and the receiving device. The first determination unit includes a second obtaining module, a third obtaining module and a second determination module, where the second obtaining module is configured to: obtain a second difference value between the first-type integrated signal strength and the second-type integrated signal strength; the third obtaining module is configured to: obtain a third difference value between the first-type first-path signal strength and the second-type first-path signal strength; and the second determination module is configured to: determine the correction distance value according to the second difference value and the third difference value. In this embodiment, although the data severely affected by the NLOS environment has been filtered out before, a data less affected by the NLOS environment may also exist. As the distance between the sending device and the receiving device varies, the interference that occurs or the degree affected by the NLOS environment is also different, and therefore parameters of the first scene (i.e., the LOS environment) and parameters of the second scene (i.e., the NLOS environment) may be used to determine whether reflection has occurred, and further a function curve may be constructed by using the first-type integrated signal strength and the first-type first-path signal strength, which may be used as a reference data for comparison with the second-type integrated signal strength and the second-type first-path signal strength, to determine the correction distance value more accurately.

To further accurately determine the correction distance value, in some other embodiments of the present disclosure, the second determination module includes a third determination sub-module, a fourth determination sub-module and a fifth determination sub-module, and the third determination sub-module is configured to: when the second difference value is smaller than a second threshold value, and the third difference value is smaller than or equal to a third threshold value, determine that the correction distance value is a first correction distance value; the fourth determination sub-module is configured to: when the second difference value is smaller than the second threshold value, the third difference value is greater than the third threshold value, and the third difference value is smaller than a fourth threshold value, determine that the correction distance value is a second correction distance value, where the fourth threshold value is greater than the third threshold value, and the second correction distance value is greater than the first correction distance value; and the fifth determination sub-module is configured to: when the second difference value is greater than or equal to the second threshold value and smaller than a fifth threshold value, and the third difference value is greater than the third threshold value and smaller than the fourth threshold value, determine the correction distance value is a third correction distance value, where the fifth threshold value is greater than the second threshold value, and the third correction distance value is greater than the second correction distance value.

To further accurately determine the correction distance value, in some other embodiments of the present disclosure, the second determination module includes a sixth determination sub-module, a seventh determination sub-module and an eighth determination sub-module, and the sixth determination sub-module is configured to: when the second difference value is greater than or equal to the fifth threshold value, and the third difference value is greater than the third threshold value and smaller than the fourth threshold value, determine the correction distance value is a fourth correction distance value, where the fourth correction distance value is greater than the third correction distance value; the seventh determination sub-module is configured to: when the second difference value is greater than or equal to the second threshold value and smaller than the fifth threshold value, and the third difference value is greater than or equal to the fourth threshold value, determine the correction distance value is a fifth correction distance value, where the fifth correction distance value is greater than the fourth correction distance value; and the eighth determination sub-module is configured to: when the second difference value is greater than or equal to the fifth threshold value and the third difference value is greater than or equal to the fourth threshold value, determine that the correction distance value is a sixth correction distance value, where the sixth correction distance value is greater than the fifth correction distance value.

In a specific embodiment of the present disclosure, the correction unit includes a third determination module and a correction module, and the third determination module is configured to: determine a current state of the sending device, where the current state is obtained by using a gyroscope sensor, the gyroscope sensor is installed in the sending device, and the current state includes a static state and a motion state; the correction module is configured to: when the current state is the motion state, correct the initial position information according to the target distance value, to obtain target position information. In this embodiment, the initial position information may be further corrected, the gyroscope sensor has a good feedback effect on position and direction, and therefore the gyroscope sensor may be used to correct the initial position information, to make the output target position information is closer to the actual situation, so that an error fluctuation is reduced.

In another specific embodiment of the present disclosure, the correction module includes a second obtaining sub-module, a ninth determination sub-module and a correction sub-module, and the second obtaining sub-module is configured to: obtain a first initial position information at a first moment and a second initial position information at a second moment, the ninth determination sub-module is configured to: determine whether an actual distance value is equal to the target distance value, where the actual distance value is a distance value of the second initial position information of the sending device relative to position information of the receiving device; and the correction sub-module is configured to: when the actual distance value is not equal to the target distance value, correct the second initial position information according to the first initial position information at the first moment and the second initial position information at the second moment, to obtain the target position information. In this embodiment, the initial position information may be further corrected, to ensure the obtained target position information is more accurate, further improving the positioning accuracy of the sending device in the NLOS environment.

In yet another specific embodiment of the present disclosure, when the motion state is a linear motion status, the correction sub-module is further configured to: construct a first function relationship by using a plurality of the first initial position information at the first moment and the second initial position information at the second moment; and the correction sub-module is further configured to: correct the second initial position information according to the first function relationship, to obtain the target position information. In this embodiment, when the motion state is a linear motion status, the initial position information may be further corrected, to ensure the obtained target position information is more accurate, further improving the positioning accuracy of the sending device in the NLOS environment.

In yet another specific embodiment of the present disclosure, when the motion state is a non-linear motion status, the correction sub-module is further configured to: determine whether an actual direction is the same as a target direction, where the actual direction refers to a direction of the second initial position information of the sending device relative to the position information of the receiving device; the correction sub-module is further configured to: when the actual direction is different from the target direction, obtain a correction slope parameter and a turning angle parameter; the correction sub-module is further configured to: construct a second function relationship by using the first initial position information at a plurality of the first moment, the second initial position information at the second moment, the correction slope parameter and the turning angle parameter; and the correction sub-module is further configured to: correct the second initial position information according to the second function relationship, to obtain the target position information. In this embodiment, when the motion state is a non-linear motion state, the initial position information may be further corrected, to ensure the obtained target position information is more accurate, further improving the positioning accuracy of the sending device in the NLOS environment.

To further accurately determine the target position information, in some other embodiments of the present disclosure, the apparatus further includes a third determination unit and a processing unit, and the third determination unit is configured to: when the current state is the static state, determine not to correct the initial position information; and the processing unit is configured to: continuously obtain the initial position information at a plurality of moments, calculate an average value of a plurality of initial position information, and determine the average value as the target position information.

Specifically, in the static state, since an error of each measurement still exists, the position information of calculation and measurement still has a slight fluctuation, which is difficult to be visible by visual perception. The gyroscope sensor may be used for continuous positioning in the static state, the obtained distance values are 5.001 cm, 4.999 cm and 5.002 cm respectively, and an average value of the three data is taken as the target position information, so that a display effect is closer to the real value without slight fluctuation.

In some other embodiments of the present disclosure, the first determination unit includes a fourth obtaining module and a fourth determination module, and the fourth obtaining module is configured to: obtain a fourth difference value between the initial distance value and the correction distance value; and the fourth determination module is configured to: determine the fourth difference value as the target distance value. In this embodiment, when the correction distance value has been determined, the fourth difference value between the initial distance value and the correction distance value is determined as the target distance value, further accurately determining the target distance value between the sending device and the receiving device.

In some embodiments of the present disclosure, the sending device includes a first UWB device, and the receiving device includes a second UWB device. In this way, a positioning position of the UWB device in the NLOS environment may be calculated.

The positioning apparatus includes a processor and a memory, where the first obtaining unit, the second obtaining unit, the first determination unit, the correction unit, etc. are all stored in the memory as program units, and the processor executes the program units stored in the memory to implement corresponding functions.

The processor includes a kernel used to call a corresponding program unit from the memory. The kernel may be set one or more, and the positioning of the UWB device in the NLOS environment may be accurately calculated by adjusting the kernel parameter.

The memory may include a non-persistent memory in a computer-readable storage medium, may be a random access memory (RAM), a non-volatile memory, or a random access memory (RAM) and a non-volatile memory, etc., for example, a read-only memory (ROM) or a flash RAM, and the memory includes at least one storage chip.

An embodiment of the present disclosure provides a computer-readable storage medium, on which a program is stored, and when the program is executed by a processor, the foregoing positioning method is implemented.

An embodiment of the present disclosure provides a processor which is configured to run a program, and when the program is run, the foregoing positioning method is executed.

The present disclosure further provides a positioning system, including a sending device, a receiving device and a positioning apparatus, where the positioning apparatus communicates with the sending device and the receiving device respectively, where the positioning apparatus is configured to perform any one of the above methods.

In the above system, since any one of the foregoing methods is included, the method first obtains the integrated signal strength and the first-path signal strength, then obtains the initial distance value between the sending device and the receiving device, and the initial position information of the sending device, next determines the correction distance value according to the integrated signal strength and the first-path signal strength, and corrects the initial distance value by using the correction distance value, to obtain the target distance value, and finally corrects the initial position information according to the target distance value, to obtain the target position information. In this solution, the position information of the sending device is corrected through multiple steps in NLOS environment, which may correct the position information and navigation route of the sending device in the NLOS environment, and therefore reducing the influence degree of the positioning of the sending device in the NLOS environment, further improving positioning accuracy of the sending device in the NLOS environment. Meanwhile, the solution can reduce the deviation of the radio communication ranging or positioning position, so that the measurement value in the NLOS environment is closer to the actual value.

An embodiment of the present disclosure provides a device, including a processor, a memory, and a program stored in the memory and executable on the processor, where when the processor executes the program, at least the following steps are implemented.

S101, obtaining an integrated signal strength and a first-path signal strength, where the integrated signal strength is determined according to strengths of a plurality of signals sent by a sending device, and the first-path signal strength is a strength of the first signal received by a receiving device.

S102, obtaining an initial distance value between the sending device and the receiving device, and an initial position information of the sending device.

S103, determining a correction distance value according to the integrated signal strength and the first-path signal strength, and correcting the initial distance value by using the correction distance value, to obtain a target distance value.

S104, correcting the initial position information according to the target distance value, to obtain a target position information.

The device herein may be a server, a PC, a PAD, a mobile phone, etc.

The present disclosure further provides a computer program product, which, when executed on a data processing device, is adapted to execute a program for initializing at least the following method steps:
S101, obtaining an integrated signal strength and a first-path signal strength, where the integrated signal strength is determined according to strengths of a plurality of signals sent by a sending device, and the first-path signal strength is a strength of the first signal received by a receiving device;
S102, obtaining an initial distance value between the sending device and the receiving device, and an initial position information of the sending device;
S103, determining a correction distance value according to the integrated signal strength and the first-path signal strength, and correcting the initial distance value by using the correction distance value, to obtain a target distance value;
S104, correcting the initial position information according to the target distance value, to obtain a target position information.

In order to make the technical solutions of the present disclosure be more clearly understood for a person skilled in the art, the following will describe the technical solutions and technical effects of the present disclosure with reference to specific embodiments.

### Embodiments

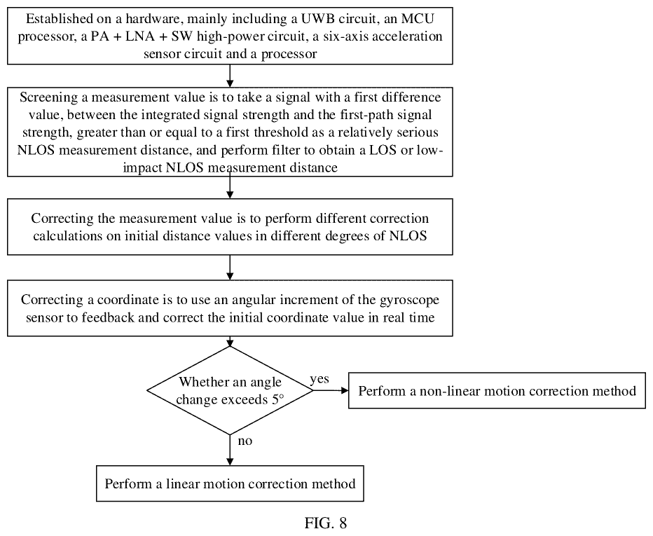

The embodiment relates to a positioning method, as shown in FIG. 8, the solution including the following contents.

An implementation of the solution may be established on a hardware, mainly including a UWB circuit, an MCU processor, a PA+LNA+SW high-power circuit, a six-axis acceleration sensor circuit and a processor.

Screening a measurement value is to take a signal with a first difference value, between the integrated signal strength and the first-path signal strength, greater than or equal to a first threshold as a relatively serious NLOS measurement distance, and perform filter to obtain a LOS or low-impact NLOS measurement distance.

Correcting the measurement value is to perform different correction calculations on initial distance values in different degrees of NLOS.

Correcting a coordinate is to use an angular increment of the gyroscope sensor to feedback and correct the initial coordinate value in real time.

Determining whether an angle change exceeds 5°, if so, perform a non-linear motion correction method; and if not, perform a linear motion correction method.

In some embodiments provided in the present disclosure, it should be understood that the disclosed technical content may be implemented in other manners. The apparatus embodiments described above are merely illustrative, for example, a division of the foregoing units may be a logical function division, and in actual implementation, there may be another division manner. For example, a plurality of units or components may be combined or integrated into another system, or some features may be ignored or not performed. In addition, the shown or discussed coupling or direct coupling or communication connection may be accomplished through indirect coupling or communication connection between some interfaces, devices or units, or may be electrical, mechanical, or in other forms.

The units described as separate parts may or may not be physically separate, and components shown as units may or may not be physical units, that is, may be located in one position, or may be distributed on a plurality of units. According to actual necessity, part or all of the units may be selected to achieve an objective of the solutions of the embodiments.

In addition, functional units in the embodiments of the present disclosure may be integrated into one processing unit, or each of the units may exist alone physically or two or more units are integrated into one unit. The integrated unit may be implemented in a form of hardware, or may be implemented in a form of a software functional unit.

If the integrated unit is implemented in the form of software functional unit and sold or used as an independent product, it may be stored in a computer-readable storage medium. Based on such understanding, the technical solutions of the present disclosure or the part that makes contribution to relevant technology, or all of the technical solutions, may be embodied in the form of a software product, the computer software product is stored in a storage medium, and includes several instructions for making a computer device (may be a personal computer, a server, a network device, etc.) to perform all or part of the steps of the above method in the embodiments of the present disclosure. The above storage medium includes a medium that can store program code, such as a U disk, a read-only memory (ROM), a random access memory (RAM), a portable hard disk, a magnetic disk, or an optical disk.

From the above description, it can be seen that the above embodiments of the present disclosure achieve the following technical effects.

Firstly, in the positioning method of the present disclosure, obtaining the integrated signal strength and the first-path signal strength at first, then obtaining the initial distance value between the sending device and the receiving device, and the initial position information of the sending device, next determining the correction distance value according to the integrated signal strength and the first-path signal strength, and correcting the initial distance value by using the correction distance value, to obtain the target distance value, and finally correcting the initial position information according to the target distance value, to obtain the target position information. In this solution, the position information of the sending device is corrected through multiple steps in NLOS environment, which may correct the position information and navigation route of the sending device in the NLOS environment, and therefore reducing the influence degree of the positioning of the sending device in the NLOS environment, further improving positioning accuracy of the sending device in the NLOS environment. Meanwhile, the solution can reduce the deviation of the radio communication ranging or positioning position, so that the measurement value in the NLOS environment is closer to the actual value.

Secondly, the positioning apparatus of the present disclosure, the first obtaining unit obtains the integrated signal strength and the first-path signal strength firstly, then the second obtaining unit obtains the initial distance value between the sending device and the receiving device, and the initial position information of the sending device, next the first determination unit determines the correction distance value according to the integrated signal strength and the first-path signal strength, and correcting the initial distance value by using the correction distance value to obtain the target distance value, and the correction unit corrects the initial position information according to the target distance value, to obtain the target position information at last. In this solution, the position information of the sending device is corrected through multiple steps in NLOS environment, which may correct the position information and navigation route of the sending device in the NLOS environment, and therefore reducing the influence degree of the positioning of the sending device in the NLOS environment, further improving positioning accuracy of the sending device in the NLOS environment. Meanwhile, the solution can reduce the deviation of the radio communication ranging or positioning position, so that the measurement value in the NLOS environment is closer to the actual value.

Lastly, in the positioning system of the present disclosure, since any one of the above methods is included, the method first obtains the integrated signal strength and the first-path signal strength, then obtains the initial distance value between the sending device and the receiving device, and the initial position information of the sending device, next determines the correction distance value according to the integrated signal strength and the first-path signal strength, and corrects the initial distance value by using the correction distance value, to obtain the target distance value, and finally corrects the initial position information according to the target distance value, to obtain the target position information. In this solution, the position information of the sending device is corrected through multiple steps in NLOS environment, which may correct the position information and navigation route of the sending device in the NLOS environment, and therefore reducing the influence degree of the positioning of the sending device in the NLOS environment, further improving positioning accuracy of the sending device in the NLOS environment. Meanwhile, the solution can reduce the deviation of the radio communication ranging or positioning position, so that the measurement value in the NLOS environment is closer to the actual value.

The foregoing descriptions are merely preferred embodiments of the present disclosure, but are not intended to limit the protection scope of the present disclosure, and for a person skilled in the art, the present disclosure may have various modifications and changes. Any modifications, equivalent replacements, etc. made within the spirit and principles of the present disclosure should be included in the protection scope of the present disclosure.

What is claimed is:

1. A positioning method, comprising:
obtaining an integrated signal strength and a first-path signal strength, wherein the integrated signal strength is determined according to strengths of a plurality of signals sent by a sending device, and the first-path signal strength is a strength of the first signal received by a receiving device;
obtaining an initial distance value between the sending device and the receiving device, and an initial position information of the sending device;
determining a correction distance value according to the integrated signal strength and the first-path signal strength, and correcting the initial distance value by using the correction distance value, to obtain a target distance value; and
correcting the initial position information according to the target distance value, to obtain a target position information.

2. The positioning method according to claim 1, wherein the obtaining an initial distance value between the sending device and the receiving device comprises:
obtaining a first difference value between the integrated signal strength and the first-path signal strength; and
determining the initial distance value between the sending device and the receiving device according to the first difference value.

3. The positioning method according to claim 2, wherein the determining the initial distance value between the sending device and the receiving device according to the first difference value comprises:
when the first difference value is smaller than a first threshold value, obtaining a first timestamp, a second timestamp, a clock frequency offset and a propagation speed of electromagnetic wave, wherein the first timestamp refers to a timestamp for sending a data packet by the sending device, and the second timestamp refers to a timestamp for receiving the data packet by the receiving device;
determining an actual time consumption according to the first timestamp, the second timestamp and the clock frequency offset, wherein the actual time consumption refers to a time actually consumed for the data packet to be sent from the sending device to the receiving device; and
determining the initial distance value between the sending device and the receiving device according to the actual time consumption and the propagation speed of electromagnetic wave.

4. The positioning method according to claim 2, further comprising:
when the first difference value is greater than or equal to the first threshold value, determining that a signal corresponding to the integrated signal strength and a signal corresponding to the first-path signal strength are both invalid signals.

5. The positioning method according to claim 1, wherein the integrated signal strength comprises a first-type integrated signal strength and a second-type integrated signal strength, the first-path signal strength comprises a first-type first-path signal strength and a second-type first-path signal strength, and the first-type integrated signal strength and the first-type first-path signal strength are obtained in a first scene, the second-type integrated signal strength and the second-type first-path signal strength are obtained in a second scene, the first scene refers to a scene in which there is no obstruction between the sending device and the receiving device, and the second scene refers to a scene in which there is an obstruction between the sending device and the receiving device, the determining a correction distance value according to the integrated signal strength and the first-path signal strength comprises:
obtaining a second difference value between the first-type integrated signal strength and the second-type integrated signal strength;
obtaining a third difference value between the first-type first-path signal strength and the second-type first-path signal strength; and
determining the correction distance value according to the second difference value and the third difference value.

6. The positioning method according to claim 5, wherein the determining the correction distance value according to the second difference value and the third difference value comprises:
when the second difference value is smaller than a second threshold value, and the third difference value is smaller than or equal to a third threshold value, determining that the correction distance value is a first correction distance value;
when the second difference value is smaller than the second threshold value, the third difference value is greater than the third threshold value, and the third difference value is smaller than a fourth threshold value, determining that the correction distance value is a second correction distance value, wherein the fourth threshold value is greater than the third threshold value, and the second correction distance value is greater than the first correction distance value; and
when the second difference value is greater than or equal to the second threshold value and smaller than a fifth threshold value, and the third difference value is greater than the third threshold value and smaller than the fourth threshold value, determining that the correction distance value is a third correction distance value, wherein the fifth threshold value is greater than the second threshold value, and the third correction distance value is greater than the second correction distance value.

7. The positioning method according to claim 6, wherein the determining the correction distance value according to the second difference value and the third difference value further comprises:
when the second difference value is greater than or equal to the fifth threshold value, and the third difference value is greater than the third threshold value and smaller than the fourth threshold value, determining that the correction distance value is a fourth correction distance value, wherein the fourth correction distance value is greater than the third correction distance value;
when the second difference value is greater than or equal to the second threshold value and smaller than the fifth threshold value, and the third difference value is greater than or equal to the fourth threshold value, determining that the correction distance value is a fifth correction distance value, wherein the fifth correction distance value is greater than the fourth correction distance value; and
when the second difference value is greater than or equal to the fifth threshold value and the third difference value is greater than or equal to the fourth threshold value, determining that the correction distance value is a sixth correction distance value, wherein the sixth correction distance value is greater than the fifth correction distance value.

8. The positioning method according to claim 1, wherein the correcting the initial position information according to the target distance value, to obtain a target position information comprises:
determining a current state of the sending device, wherein the current state is obtained by using a gyroscope sensor, the gyroscope sensor is installed in the sending device, and the current state comprises a static state and a motion state; and
when the current state is the motion state, correcting the initial position information according to the target distance value, to obtain the target position information.

9. The positioning method according to claim 8, wherein the when the current state is the motion state, correcting the initial position information according to the target distance value, to obtain the target position information comprises:
obtaining a first initial position information at a first moment and a second initial position information at a second moment;
determining whether an actual distance value is equal to the target distance value, wherein the actual distance value is a distance value of the second initial position information of the sending device relative to a position information of the receiving device; and
when the actual distance value is not equal to the target distance value, correcting the second initial position information according to the first initial position information at the first moment and the second initial position information at the second moment, to obtain the target position information.

10. The positioning method according to claim 9, wherein when the motion state is a linear motion status and the actual distance value is not equal to the target distance value, the correcting the second initial position information according to the first initial position information at the first moment and the second initial position information at the second moment, to obtain the target position information comprises:
constructing a first function relationship by using a plurality of the first initial position information at the first moment and the second initial position information at the second moment; and
correcting the second initial position information according to the first function relationship, to obtain the target position information.

11. The positioning method according to claim 9, wherein when the motion state is a non-linear motion status and the actual distance value is not equal to the target distance value, the correcting the second initial position information according to the first initial position information at the first moment and the second initial position information at the second moment, to obtain the target position information comprises:
determining whether an actual direction is the same as a target direction, wherein the actual direction refers to a direction of the second initial position information of the sending device relative to the position information of the receiving device;
when the actual direction is different from the target direction, obtaining a correction slope parameter and a turning angle parameter;
constructing a second function relationship by using the first initial position information at a plurality of the first moment, the second initial position information at the second moment, the correction slope parameter and the turning angle parameter; and
correcting the second initial position information according to the second function relationship, to obtain the target position information.

12. The positioning method according to claim 8, further comprising:
when the current state is the static state, determining not to correct the initial position information; and
continuously obtaining the initial position information at a plurality of moments, obtaining an average value of a plurality of initial position information, and determining the average value as the target position information.

13. The positioning method according to claim 1, wherein the correcting the initial distance value by using the correction distance value, to obtain a target distance value comprises:
obtaining a fourth difference value between the initial distance value and the correction distance value; and
determining the fourth difference value as the target distance value.

14. The positioning method according to claim 1, wherein the sending device comprises a first ultra wide band (UWB) device, and the receiving device comprises a second UWB device.

15. An electronic device, comprising:
a processor; and
a memory for storing instructions executable by the processor;
wherein the processor is configured to perform a positioning method, the positioning method comprises:
obtaining an integrated signal strength and a first-path signal strength, wherein the integrated signal strength is determined according to strengths of a plurality of signals sent by a sending device, and the first-path signal strength is a strength of the first signal received by a receiving device;
obtaining an initial distance value between the sending device and the receiving device, and an initial position information of the sending device;
determining a correction distance value according to the integrated signal strength and the first-path signal strength, and correcting the initial distance value by using the correction distance value, to obtain a target distance value; and
correcting the initial position information according to the target distance value, to obtain a target position information.

16. The electronic device according to claim 15, wherein the obtaining an initial distance value between the sending device and the receiving device comprises:
obtaining a first difference value between the integrated signal strength and the first-path signal strength; and
determining the initial distance value between the sending device and the receiving device according to the first difference value.

17. The electronic device according to claim 15, wherein the integrated signal strength comprises a first-type integrated signal strength and a second-type integrated signal strength, the first-path signal strength comprises a first-type first-path signal strength and a second-type first-path signal strength, and the first-type integrated signal strength and the first-type first-path signal strength are obtained in a first scene, the second-type integrated signal strength and the second-type first-path signal strength are obtained in a second scene, the first scene refers to a scene in which there is no obstruction between the sending device and the receiving device, and the second scene refers to a scene in which there is an obstruction between the sending device and the receiving device, the determining a correction distance value according to the integrated signal strength and the first-path signal strength comprises:
obtaining a second difference value between the first-type integrated signal strength and the second-type integrated signal strength;
obtaining a third difference value between the first-type first-path signal strength and the second-type first-path signal strength; and
determining the correction distance value according to the second difference value and the third difference value.

18. The electronic device according to claim 15, wherein the correcting the initial position information according to the target distance value, to obtain a target position information comprises:
determining a current state of the sending device, wherein the current state is obtained by using a gyroscope sensor, the gyroscope sensor is installed in the sending device, and the current state comprises a static state and a motion state; and
when the current state is the motion state, correcting the initial position information according to the target distance value, to obtain the target position information.

19. A non-transitory computer-readable storage medium, comprising: a stored program, which executes the positioning method according to claim 1.

20. A positioning system, comprising: a sending device, a receiving device and a positioning device, wherein the positioning device communicates with the sending device and the receiving device respectively, and the positioning device is configured to execute a positioning method, the positioning method comprises:
obtaining an integrated signal strength and a first-path signal strength, wherein the integrated signal strength is determined according to strengths of a plurality of signals sent by a sending device, and the first-path signal strength is a strength of the first signal received by a receiving device;
obtaining an initial distance value between the sending device and the receiving device, and an initial position information of the sending device;
determining a correction distance value according to the integrated signal strength and the first-path signal strength, and correcting the initial distance value by using the correction distance value, to obtain a target distance value; and
correcting the initial position information according to the target distance value, to obtain a target position information.
